(19) United States
(12) Patent Application Publication
(10) Pub. No.: US 2025/0137093 A1
(43) Pub. Date: May 1, 2025

(54) Method for recovering lithium from spent cathode of aluminum electrolysis

(71) Applicant: ZHENGZHOU NON-FERROUS METALS RESEARCH INSTITUTE CO.LTD OF CHALCO, Zhengzhou (CN)

(72) Inventors: Kaibin CHEN, Zhengzhou (CN); Zhirong SHI, Zhengzhou (CN); Tingting DU, Zhengzhou (CN); Jianjun LIU, Zhengzhou (CN); Ruonan LI, Zhengzhou (CN); Zhongsheng LUO, Zhengzhou (CN); Lizhen SUN, Zhengzhou (CN); Jianwei WU, Zhengzhou (CN); Quanhai JING, Zhengzhou (CN)

(73) Assignee: ZHENGZHOU NON-FERROUS METALS RESEARCH INSTITUTE CO.LTD OF CHALCO, Zhengzhou, HE (CN)

(21) Appl. No.: 19/012,609

(22) Filed: Jan. 7, 2025

Related U.S. Application Data
(63) Continuation of application No. PCT/CN2024/080014, filed on Mar. 5, 2024.

(30) Foreign Application Priority Data
May 25, 2023 (CN) 202310614036.8

(51) Int. Cl. C22B 26/12; C22B 1/248; C22B 3/22; C22B 3/44; C22B 7/00

(52) U.S. Cl. CPC C22B 26/12; C22B 1/248; C22B 3/22; C22B 3/44; C22B 7/006

(57) ABSTRACT

A method for recovering a lithium from a spent cathode of aluminum electrolysis according to an embodiment of the disclosure includes: crushing the spent cathode, then washing and filtering the spent cathode to obtain a first filtrate and a first filter residue, respectively; evaporating and crystallizing the first filtrate to obtain a sodium fluoride product; adding a binder into the first filter residue, and mixing and shaping the first filter residue and the binder, and then calcining and collecting shaped first filter residue to obtain a graphite product and a dust collection powder; lithium-salt leaching the dust collection powder with pure water and filtering to obtain a second filtrate and a second filter residue; washing the second filter residue, and then drying the second filter residue to obtain a cryolite product; and adding the second filtrate into a carbonas solution to perform a lithium precipitation reaction to obtain a lithium carbonas product.

### CROSS-REFERENCE TO RELATED APPLICATIONS

The application claims the priority to Chinese patent application No. 2023106140368, filed on May 12, 2023, the entire contents of which are incorporated herein by reference.

### TECHNICAL FIELD

The disclosure relates to the technical field of hazardous solid waste recovery, and in particular to a method for recovering a lithium from a spent cathode of aluminum electrolysis.

### BACKGROUND

A spent cathode of aluminum electrolysis is an inevitable hazardous waste in a process of aluminum electrolysis production. Carbonaceous materials, fluoride salts and lithium salts in the production process of aluminum electrolysis each have high recycling value. At present, as for most of lithium extraction methods for remaining recyclable materials of the spent cathode of aluminum electrolysis, acid or alkali addition methods are used to improve a conversion rate of the lithium salts. However, there are problems such as long process and high requirement for equipment. Under the action of sulfuric acid and alkali solution, various impurities in raw materials will be dissolved together in a dissolution process, making subsequent impurity removal difficult. In addition, acid addition and roasting will cause environmental problems such as toxic gas hydrogen fluoride, resulting in a poor working environment and serious environmental pollution.

### SUMMARY

The disclosure provides a method for recovering a lithium from a spent cathode of aluminum electrolysis, so as to solve technical problems in the related art that it is difficult to completely recycle the spent cathode without generating new pollutants by acid leaching, alkali leaching or roasting.

A method for recovering a lithium from a spent cathode of aluminum electrolysis according to an embodiment of the disclosure includes: crushing the spent cathode, then washing and filtering the spent cathode to obtain a first filtrate and a first filter residue; evaporating and crystallizing the first filtrate to obtain a sodium fluoride product; adding a binder into the first filter residue, and mixing and shaping the first filter residue and the binder, and then calcining and collecting the first filter residue shaped to obtain a graphite product and a dust collection powder; leaching the dust collection powder with pure water and filtering to obtain a second filtrate and a second filter residue; washing the second filter residue, and then drying the second filter residue to obtain a cryolite product; and adding the second filtrate into a carbonas solution so as to perform a lithium precipitation reaction to obtain a lithium carbonas product.

### BRIEF DESCRIPTION OF DRAWINGS

The accompanying drawings, which are incorporated in and constitute a portion of this specification, illustrate embodiments consistent with the disclosure and serve to explain principles of the disclosure together with the description.

In order to more clearly illustrate the embodiments of the disclosure or the technical solutions in the related art, the accompanying drawings needed to be used in the description of the embodiments or the related art will be briefly introduced below. Obviously, for those skilled in the art, other accompanying drawings can also be obtained based on these accompanying drawings without creative efforts.

FIG. 1 is a schematic flow diagram of a method for recovering a lithium from a spent cathode of aluminum electrolysis according to some embodiments of the disclosure.

FIG. 2 is a detailed schematic flow diagram of a method for recovering a lithium from a spent cathode of aluminum electrolysis according to some embodiments of the disclosure.

### DESCRIPTION OF EMBODIMENTS

In order to make purposes, technical solutions and advantages of some embodiments of the disclosure clearer, the technical solutions in some embodiments of the disclosure will be clearly and completely described below in conjunction with the accompanying drawing according to the embodiments of the disclosure. Obviously, the described embodiments are some embodiments of the disclosure, but not all embodiments. Based on the embodiments in the disclosure, all other embodiments obtained by those skilled in the art without any creative efforts fall within the scope of protection sought by the disclosure.

Unless otherwise specified, various raw materials, reagents, instruments, and equipment used in the disclosure are commercially available or obtained through existing methods.

At present, methods for extracting a lithium from a spent cathode of aluminum electrolysis mainly include:
1. A method for preparing lithium carbonas using aluminum-containing lithium electrolytic materials, including: crushing surplus electrolyte-containing materials produced in aluminum electrolysis production, adding crushed materials, aluminum salt solution, inorganic acid, and water in proportion into a reactor for concentration, centrifugation and so on to extract a lithium carbonas product;
2. A method for efficiently extracting lithium and preparing anhydrous aluminum fluoride from lithium-rich aluminum electrolyte waste, belonging to the technical field of non-ferrous metal extraction; in the method, a concentrated sulfuric acid and the lithium-rich aluminum electrolyte waste are uniformly mixed and cured, and then heated to generate a HF gas and a water-soluble defluorinated sulfate, and then an obtained defluorinated sulfate material is leached with water; an aluminum is then selectively extracted from an obtained leaching solution; then extracted load organic phase obtained by extracting the aluminum is introduced into a dedusted and decontaminated HF gas to generate an aluminum fluoride powder; a raffinate obtained by extracting aluminum is deeply purified to remove calcium and magnesium, and then sodium carbonas is used for a lithium precipitation reaction to obtain pure lithium carbonas product; the raffinate after the lithium precipitation reaction is evaporated and concentrated, and then is cooled and crystallized to obtain a potassium sulfate and a sodium sulfate;
3. A method for recovering a carbon from a spent cathode of aluminum electrolysis, including: step 1. crushing spent cathode carbon blocks of aluminum electrolysis cells to obtain spare particles; step 2. uniformly mixing the spare particles obtained in step 1 with solid alkali, adding a deionized water to the mixture, and standing the deionized water and the mixture, and then evaporating the deionized water and the mixture for removing water to obtain a mixture material; step 3. heating the mixture material obtained in step 2 to be a temperature of 320-700° C. in a protective atmosphere and keeping the temperature for 0.5-4 h, and cooling the mixture material and then washing the mixture material with water to be neutrality, and then filtering and drying the mixture material to obtain an alkaline slag; and step 4. adding the alkaline slag obtained in step 3 to a mixed solution of acid and sodium fluoride for leaching, and then filtering, and washing with water to be neutrality to obtain a carbon powder;
4. A method for recovering a lithium and a potassium from a high-lithium-potassium anode carbon residue or high-lithium-potassium electrolyte, including: (1) grinding the high-lithium-potassium anode carbon residue or the high-lithium-potassium electrolyte to be fine as a raw material, and then mixing the raw material with a concentrated sulfuric acid solution and heating to 280-500° C. for a reaction; (2) adding water to a material after the reaction for leaching, and filtering the mixture of the material and water to separate a first filtrate; (3) adjusting, when a temperature of the first filtrate is ≤30° C., a pH value of the first filtrate to be 6-8, and then filtering the first filtrate after the pH value is adjusted to separate a secondary filtrate; (4) cooling the secondary filtrate to be −5˜10° C. so as to precipitate a sodium sulfate in the secondary filtrate; filtering the secondary filtrate at this time to separate a tertiary filtrate; (5) heating the tertiary filtrate to be 90-100° C. or adding a sodium carbonas into a boiling tertiary filtrate to make a carbonate of the sodium carbonas to react with a lithium in the tertiary solution to form a precipitation of lithium carbonas for precipitation, and filtering the tertiary filtrate to separate the lithium carbonas and a fourth filtrate; (6) cooling the fourth filtrate to be −5˜10° C. to precipitate a sodium sulfate in the fourth filtrate, and filtering the fourth filtrate at this time to separate a potassium sulfate solution, and then concentrating or dehydrating the potassium sulfate solution to obtain a hydrated potassium sulfate or directly obtain a potassium sulfate product.

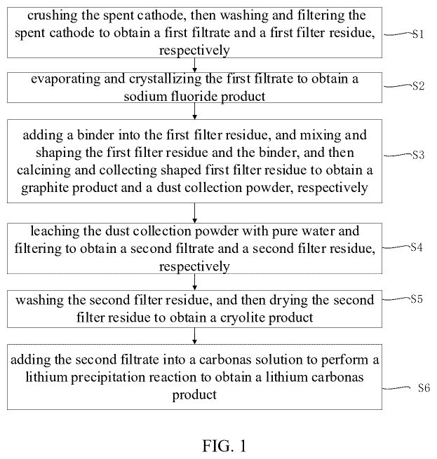

FIG. 1 is a schematic flow diagram of a method for recovering a lithium from a spent cathode of aluminum electrolysis according to some embodiments of the disclosure. As shown in FIG. 1, a method for recovering a lithium from a spent cathode of aluminum electrolysis according to an embodiment of the disclosure includes: step S1, crushing the spent cathode, and then washing and filtering the spent cathode to obtain a first filtrate and a first filter residue; step S2, evaporating and crystallizing the first filtrate to obtain a sodium fluoride product; step S3, adding a binder into the first filter residue, and mixing and shaping the first filter residue and the binder, and then calcining and collecting the shaped first filter residue to obtain a graphite product and a dust collection powder; step S4, leaching the dust collection powder with pure water and filtering to obtain a second filtrate and a second filter residue; step S5, washing the second filter residue, and then drying the second filter residue to obtain a cryolite product; and step S6, adding the second filtrate into a carbonas solution to perform a lithium precipitation reaction to obtain a lithium carbonas product.

In some embodiments, compared with traditional acid leaching or alkaline leaching methods, influences of impurities in a simple acid leaching or alkaline leaching process are avoided, and different compositions of the spent cathode can be collected separately, and no toxic gas hydrogen fluoride is produced, thereby achieving complete recycling of the spent cathode without generating new pollutants.

In some embodiments, a temperature of the calcining is 2000° C. to 2600° C.

In some embodiments, controlling a specific temperature of the calcining can ensure that a carbon element in the spent cathode can form a graphite product, and at the same time ensure that cryolite components and lithium elements other than carbon in the spent cathode form the dust collection powder, thereby facilitating subsequent extraction and recovery for the cryolite and lithium elements in the dust collection powder.

The calcining can be performed in a vertical high temperature continuous graphitization furnace.

In some embodiments, a target granularity for the crushing is 200 mesh to 250 mesh.

In some embodiments, controlling the target granularity for the crushing as 200 mesh to 250 mesh has positive effects as follows: compositions of the spent cathode raw materials will vary due to differences in regions, ages of the electrolytic cell, and sampling locations, and therefore, within a range of this target granularity, it is ensured that the spent cathode, after being crushed, has a suitable specific surface area, thereby facilitating a water washing to remove a sodium salt from the spent cathode, and at the same time improving a bonding effect of subsequent adhesive, ensuring sufficient subsequent calcining, so that the graphite product and dust collection powder can be obtained.

In some embodiments, a solid-liquid ratio for the water washing is 1:3 to 1:5, and a time of the water washing is 45 min to 60 min.

In some embodiments, controlling a specific solid-liquid ratio and the time of the water washing can ensure that the sodium salt and a soluble fluorine on the spent cathode are completely washed off, thereby ensuring that sufficient sodium fluoride products are obtained subsequently, and ensuring purities of subsequent graphite products, cryolite products, and lithium carbonas products.

In some embodiments, the dust collection powder includes a lithium-containing cryolite.

In some embodiments, controlling the specific composition of the dust collection powder can ensure that there are sufficient lithium and cryolite components in the dust collection powder, thereby ensuring that pure cryolite and lithium carbonas products are obtained.

In some embodiments, a temperature of the leaching is room temperature, and a time of the leaching is 90 min to 120 min.

In some embodiments, controlling a specific temperature and specific time of leaching can ensure an extraction effect of pure water on the lithium elements in the dust collection powder, and ensure that a sufficient amount of lithium salt solution is finally formed, thereby forming a sufficient amount of lithium carbonas product. In this embodiment, pure water can be used at room temperature to extract lithium salts from the dust collection powder, and a dissolving solution has a high lithium content and extremely low content of lithium in impurities, and the lithium precipitation reaction can be directly performed on the dissolving solution.

In some embodiments, an addition amount of the carbonas solution is 1.1 to 1.3 times a theoretical addition amount of the carbonas solution. The theoretical addition amount of the carbonas solution is calculated from a lithium content in the second filtrate.

In some embodiments, controlling a specific relationship between the addition amount of the carbonas solution and the theoretical addition amount of the carbonas solution can ensure that the carbonas solution fully reacts with a lithium in a solution from which the dust collection powder has been leached, thereby obtaining the lithium carbonas product which is sufficiently pure and has sufficient output while avoiding waste of the carbonas solution.

The theoretical addition amount of the carbonas solution is calculated by calculating a mass of carbonate required for complete reaction is calculated according to a molar ratio of carbonas to lithium ion of 1:2.

In some embodiments, a concentration of lithium ions in the second filtrate is ≥10 g/L.

In some embodiments, controlling a specific concentration of the lithium ions in the second filtrate can ensure that there is enough lithium in the second filtrate, thereby ensuring that subsequent reaction between the second filtrate and the carbonas solution is complete to obtain the lithium carbonas product which is sufficiently pure and has sufficient output, and improving a recovery rate of the lithium.

In some embodiments, a temperature of the lithium precipitation reaction is 90° C. to 100° C., and a time of the lithium precipitation reaction is 90 min to 120 min.

In some embodiments, controlling a specific reaction temperature and reaction time can ensure that the carbonas solution fully reacts with a lithium in a solution from which the dust collection powder is leached, thereby be able to obtain the lithium carbonas product which is sufficiently pure and has sufficient output, and improving a recovery rate of the lithium.

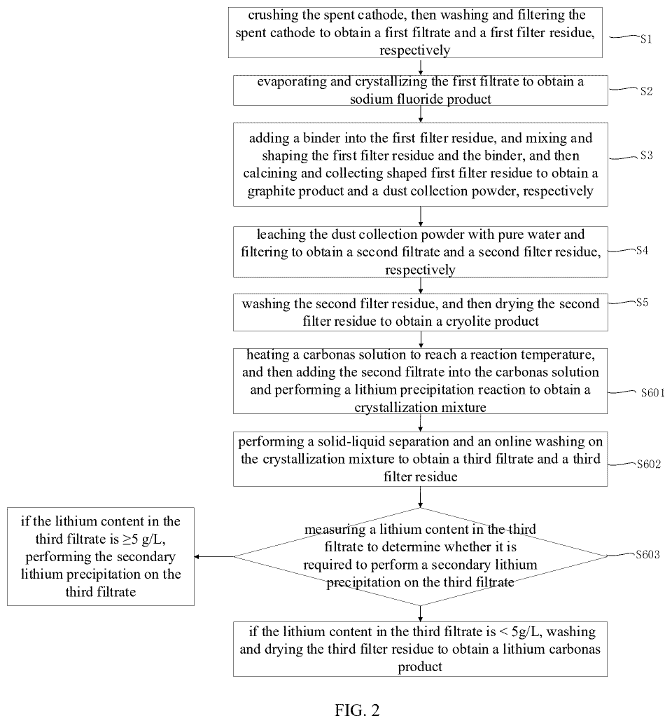

FIG. 2 is a detailed schematic flow diagram of a method for recovering a lithium from a spent cathode of aluminum electrolysis according to some embodiments of the disclosure. As shown in FIG. 2, in some embodiments, the adding the second filtrate into a carbonas solution to perform a lithium precipitation reaction so as to obtain a lithium carbonas product may also include: step S601, heating the carbonas solution to reach a reaction temperature, and then adding the second filtrate into the carbonas solution and performing a lithium precipitation reaction to obtain a precipitation mixture; step S602, performing a solid-liquid separation and an online washing on the precipitation mixture to obtain a third filtrate and a third filter residue; and step S603, measuring a lithium content in the third filtrate to determine whether it is required to perform a secondary lithium precipitation on the third filtrate; if the lithium content in the third filtrate is ≥5 g/L, performing the secondary lithium precipitation on the third filtrate; and if the lithium content in the third filtrate is <5 g/L, washing and drying the third filter residue to obtain a lithium carbonas product.

In some embodiments, controlling a specific reaction process for the carbonas solution and the second filtrate can not only ensure that the lithium in the carbonas solution reacts with the second filtrate completely, but also ensure a purity and quality of generated lithium carbonas product, while a recovery rate of the lithium is improved.

The solid-liquid separation can be performed by washing with an appropriate amount of hot water to obtain the lithium carbonas product with higher purity.

The disclosure is further described below in conjunction with specific examples. It should be understood that these examples are only used to illustrate the disclosure and are not intended to limit a scope sought for by the disclosure. Experimental methods without specifying specific conditions in the following examples are typically performed in accordance with national standards in China. If there is no corresponding national standards in China, general international standards, conventional conditions, or conditions recommended by the manufacturer shall be followed.

### Example 1

As shown in FIG. 2, a method for recovering a lithium from a spent cathode in an aluminum electrolysis includes:
Step S1, crushing the spent cathode, then washing and filtering the spent cathode to obtain a first filtrate and a first filter residue;
Step S2, evaporating and crystallizing the first filtrate to obtain a sodium fluoride product;
Step S3, adding a binder into the first filter residue, and mixing and shaping the first filter residue and the binder, and then calcining and collecting shaped first filter residue to obtain a graphite product and a dust collection powder;
Step S4, leaching the dust collection powder with pure water and filtering to obtain a second filtrate and a second filter residue;
Step S5, washing the second filter residue, and then drying the second filter residue to obtain a cryolite product;
Step S601, heating a carbonas solution to reach a reaction temperature, and then adding the second filtrate into the carbonas solution and performing a lithium precipitation reaction to obtain a crystallization mixture;
Step S602, performing a solid-liquid separation and an online washing on the crystallization mixture to obtain a third filtrate and a third filter residue;
Step S603, measuring a lithium content in the third filtrate to determine whether it is required to perform a secondary lithium precipitation on the third filtrate;

If the lithium content in the third filtrate is ≥5 g/L, performing the secondary lithium precipitation on the third filtrate;
and if the lithium content in the third filtrate is <5 g/L, washing and drying the third filter residue to obtain a lithium carbonas product.

A temperature of the calcining is 2000° C.

A target granularity of the crushing is 200 mesh.

A solid-liquid ratio for the water washing is 1:3, and a time of the water washing is 60 minutes.

The dust collection powder includes a lithium-containing cryolite.

A temperature of the leaching is room temperature, and a time of the leaching is 120 minutes.

An addition amount of the carbonas solution is 1.1 times a theoretical amount of the carbonas solution.

A concentration of lithium ions in the second filtrate is ≥10 g/L.

A temperature of the lithium precipitation reaction is 100° C., and a time of the lithium precipitation reaction is 90 min.

### Example 2

Comparing Example 2 with Example 1, differences between Example 2 and Example 1 are:

A temperature of the calcining is 2600° C.

A target granularity of the crushing is 250 mesh.

A solid-liquid ratio for the water washing is 1:4, and a time of the water washing is 50 minutes.

A temperature of the leaching is room temperature, and a time of the leaching is 90 minutes.

An addition amount of the carbonas solution is 1.3 times a theoretical amount of the carbonas solution.

A temperature of the lithium precipitation reaction is 90° C., and a time of the lithium precipitation reaction is 120 min.

### Example 3

Comparing Example 3 with Example 1, differences between Example 3 and Example 1 are:

The temperature of the calcining is 2400° C.

A target granularity of the crushing is 230 mesh.

A solid-liquid ratio for the water washing is 1:5, and a time of the water washing is 45 minutes.

A temperature of the leaching is room temperature, and a time of the leaching is 100 minutes.

An addition amount of the carbonas solution is 1.2 times a theoretical amount of the carbonas solution.

A temperature of the lithium precipitation reaction is 95° C., and a time of the lithium precipitation reaction is 110 min.

### Related Test and Effect Data:

Statuses of indicators for the graphite product obtained in Example 1 are shown in Table 1.

TABLE 1
Indicators of graphite product

| | True | Powder | Ash | Fixed | |
|---|---|---|---|---|---|
| | density | resistivity | content | carbon | Graphitization |
| item | (g/cm³) | (μΩ · m) | (%) | (%) | degree (%) |
| Graphitized | 2.20 | 60-90 | 0.216 | 99.64 | 98.8 |
| products | | | | | |

Ion contents in the second filtrate obtained in Example 1 are shown in Table 2.

TABLE 2
Distribution of ion contents in the second filtrate

| ions | F | Ca | Li | Na | Fe | Cu | Ni | B | Mn | Mg | Si | Al |
|---|---|---|---|---|---|---|---|---|---|---|---|---|
| Content | 35.85 | 3.1 | 12452 | 65000 | 0 | 0 | 0 | 0.095 | 0.071 | 0.091 | 0.0 | 0.0 |
| (mg/L) | | | | | | | | | | | | |

Statuses of indicators for the lithium carbonas product obtained in Example 1 are shown in Table 3.

TABLE 3
Indicators of lithium carbonas product

| | | | | | sulfate | |
|---|---|---|---|---|---|---|
| content(%) | Li₂CO₃ | Na | Fe | Ca | radical | Chloridion |
| Lithium | 95.45 | 1.04 | 0.0025 | 0.031 | 0.28 | 0.02 |
| carbonas | | | | | | |
| after | | | | | | |
| solid-liquid | | | | | | |
| separation | | | | | | |
| Lithium | 99.07 | 0.11 | 0.0020 | 0.030 | 0.069 | 0.02 |
| carbonas | | | | | | |
| after online | | | | | | |
| washing | | | | | | |

According to one or more technical solutions of the embodiments of the disclosure, at least the following technical effects or advantages are achieved:
(1) A method for recovering a lithium from a spent cathode of aluminum electrolysis is provided according to some embodiments of the disclosure, which mainly includes: grinding the spent cathode for washing with water to remove a soluble fluorine, and then aggregating the spent cathode together through an action of a binder, and then calcining the spent cathode in a graphitization furnace to obtain crushed graphite products. Dust collection powder, which is generated during the calcining, are leached to extract lithium, and finally a lithium carbonas product and cryolite product are obtained. Above process of this method does not use acid or alkali, and the process is simple, environmentally friendly, and easy to operate.
(2) A method for recovering a lithium from a spent cathode of aluminum electrolysis is provided according to some embodiments of the disclosure, in which, in a stage of leaching lithium salt, pure water can be used at room temperature to achieve efficient leaching of lithium in the dust collection powder. Reaction conditions are mild, and the lithium content is high and an impurity content is extremely low in a dissolving solution. The lithium precipitation reaction can be directly performed on the dissolving solution without need for an impurity removal treatment on the dissolving solution.
(3) A method for recovering a lithium from a spent cathode of aluminum electrolysis is provided according to some embodiments of the disclosure, which realizes resource utilization, high value creation and full utilization of hazardous waste such as the spent cathode. No new pollutants are generated in whole process, and four products with good economic benefits are obtained.

A method for completely recycling a spent cathode without generating new pollutants is provided according to an embodiment of the disclosure. Through a series of processes, a soluble fluoride salt in the spent cathode is converted into a sodium fluoride product, and carbonaceous materials are converted at a high temperature into high-value graphitized products, and remaining regenerants are converted into a cryolite product and a lithium carbonas product, thereby realizing resource utilization, high value creation and full utilization of the spent cathode throughout entire process, thereby maximizing environmental and economic benefits.

According to a method for recovering a lithium from a spent cathode of aluminum electrolysis is provided according to some embodiments of the disclosure, in which the spent cathode is first washed with water, and then a washing filtrate is evaporated and crystallized to wash away a soluble sodium fluoride attached to the spent cathode, and then a binder is added to bond the filter residue after washing, and a bonded filter residue is calcined, so that a graphite product can be obtained by a high-temperature calcining, and a dust collection powder containing lithium is obtained, and then the dust collection powder is leached so that the lithium in the dust collection powder can be leached out by only using water at room temperature, and a leached dust collection powder is filtered to obtain a filter residue and a filtrate, and then the filter residue is dried to obtain a cryolite, and finally the filtrate is reacted with a carbonas solution to obtain a high-purity lithium carbonas product. In this method, compared with traditional acid leaching or alkaline leaching methods, influences of impurities in a simple acid leaching or alkaline leaching process are avoided, and different compositions of the spent cathode can be collected separately, and no toxic gas hydrogen fluoride is produced, thereby achieving complete recycling of the spent cathode without generating new pollutants.

Various embodiments of the present disclosure may exist in the form of a range; it should be understood that the description in the form of a range is only for convenience and simplicity and should not be understood as a hard limit to the scope of the present disclosure; therefore, the described range should be considered to have specifically disclosed all possible subranges as well as the single values within such a range. For example, a description of a range from 1 to 6 should be considered to have disclosed subranges, such as from 1 to 3, from 1 to 4, from 1 to 5, from 2 to 4, from 2 to 6, and from 3 to 6, and a single number within the stated range, such as 1, 2, 3, 4, 5, and 6, which applies regardless of the range. Additionally, whenever a numerical range is indicated herein, it is intended to include any cited number (fractional or whole) within the indicated range.

In the disclosure, unless otherwise specified, the directional words used such as “upper” and “lower” refer specifically to the direction of the figure in the drawing. In addition, in the description of the present disclosure, the terms “including”, “comprising” and the like refer to “including but not limited to”. In the disclosure, relational terms such as “first” and “second” are merely used to distinguish one entity or operation from another and do not necessarily require or imply any such actual relationship or sequence between these entities or operations. In the disclosure, “and/or” describes the relationship between associated objects, indicating that there may be three relationships. For example, A and/or B may refer to: A alone, both A and B, and B alone. In which, A and B can be singular or plural. In the disclosure, “at least one” refers to one or more, and “plurality” refers to two or more. “At least one”, “at least one of the following” or similar expressions thereof refers to any combination of these items, including single items or any combination of plural items. For example, “at least one of a, b, or c”, or “at least one of a, b, and c” may represent: a, b, c, a˜b (that is, a and b), a˜c, b˜c, or a˜b˜c in which a, b, and c can each be single or multiple.

The above descriptions are only embodiments of the disclosure, enabling those skilled in the art to understand or implement the disclosure. Various modifications to these embodiments will be readily apparent to those skilled in the art, and the generic principle defined in the disclosure may be practiced in other embodiments without departing from the spirit or scope of the disclosure. Therefore, the disclosure is not to be limited to the embodiments shown in the disclosure but is to be accorded the widest scope consistent with the principles and novel features claimed in the disclosure.

What is claimed is:

1. A method for recovering a lithium from a spent cathode of aluminum electrolysis, comprising:
crushing the spent cathode, then washing and filtering the spent cathode to obtain a first filtrate and a first filter residue;
evaporating and crystallizing the first filtrate to obtain a sodium fluoride product;
adding a binder into the first filter residue, and mixing and shaping the first filter residue and the binder, and then calcining and collecting the first filter residue shaped to obtain a graphite product and a dust collection powder;
leaching the dust collection powder with pure water and filtering to obtain a second filtrate and a second filter residue;
drying the second filter residue to obtain a cryolite product; and
adding the second filtrate into a carbonas solution to perform a lithium precipitation reaction so as to obtain a lithium carbonas product.

2. The method according to claim 1, wherein a temperature of the calcining is 2000° C. to 2600° C.

3. The method according to claim 1, wherein a target granularity for the crushing is 200 mesh to 250 mesh.

4. The method according to claim 1, wherein the dust collection powder comprises a lithium-containing cryolite.

5. The method according to claim 1, wherein a temperature for leaching the dust collection powder is room temperature, and a time of the leaching is 90 min to 120 min.

6. The method according to claim 1, wherein an addition amount of the carbonas solution is 1.1 to 1.3 times a theoretical addition amount of the carbonas solution, the theoretical addition amount of the carbonas solution being calculated from a lithium content in the second filtrate.

7. The method according to claim 1, wherein a concentration of lithium ions in the second filtrate is ≥10 g/L.

8. The method according to claim 1, wherein a temperature of the lithium precipitation reaction is 90° C. to 100° C., and a time of the lithium precipitation reaction is 90 min to 120 min.

9. The method according to claim 1, wherein the adding the second filtrate into the carbonas solution to perform a reaction, and then evaporating to obtain the lithium carbonas product comprises:
heating a carbonas solution to reach a reaction temperature, and then adding the second filtrate into the carbonas solution to react so as to obtain a crystallization mixture;
performing a solid-liquid separation and an online washing on the crystallization mixture to obtain a third filtrate and a third filter residue;
measuring a lithium content in the third filtrate to determine whether it is required to perform a secondary lithium precipitation on the third filtrate;
if the lithium content in the third filtrate is ≥5 g/L, performing the secondary lithium precipitation on the third filtrate; and
if the lithium content in the third filtrate is <5 g/L, washing and drying the third filter residue to obtain a lithium carbonas product.
